(19) United States
(12) Patent Application Publication
(10) Pub. No.: US 2010/0321079 A1
(43) Pub. Date: Dec. 23, 2010

(54) SEMICONDUCTOR INTEGRATED CIRCUIT

(75) Inventors: Hirotomo Ishii, Kanagawa (JP); Tetsuya Nakamura, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/817,470

(22) Filed: Jun. 17, 2010

(30) Foreign Application Priority Data
Jun. 19, 2009 (JP) 2009-146848

(51) Int. Cl. G05F 3/02

(52) U.S. Cl. 327/198; 327/538; 327/543

(57) ABSTRACT

Certain embodiments provide an electronic circuit and a correction circuit. The electronic circuit includes a plurality of semiconductor elements. The correction circuit controls voltage of the semiconductor elements such that a difference between electric characteristics of the semiconductor elements autonomously decreases.

### CROSS-REFERENCE TO RELATED APPLICATIONS

This application is based upon and claims the benefit of priority from the prior Japanese Patent Application No. 2009-146848, filed on Jun. 19, 2009; the entire contents of which are incorporated herein by reference.

### BACKGROUND

1. Field

Embodiments described herein relates generally to a semiconductor integrated circuit, and, more particularly is suitably applied to a method of correcting fluctuation in absolute values of threshold voltages between field effect transistors due to a manufacturing process or negative bias temperature instability (NBTI).

2. Description of the Related Art

In a field effect transistor, fluctuation occurs in an absolute value of a threshold voltage because of a manufacturing process. It is known that a P-channel field effect transistor deteriorates with time because of NBTI. The deterioration with time due to NBTI is a phenomenon in which, when the P-channel field effect transistor is operated for a long time under a high-temperature condition (e.g., when a source voltage and a drain voltage are 0 volt and a gate voltage is negative bias), an absolute value of a threshold voltage of the P-channel field effect transistor increases and a current driving ability falls.

To suppress the fluctuation in the absolute value of the threshold voltage of the field effect transistor due to the manufacturing process, a method of increasing a gate area of the field effect transistor is effective.

For example, it discloses a method of applying negative potential to a gate of a drive transistor as reverse bias, which has negative polarity in source reference, and correcting upward fluctuation in threshold voltage caused by application of forward bias downward.

However, in the method of increasing a gate area of the field effect transistor to suppress the fluctuation in the absolute value of the threshold voltage of the field effect transistor, a circuit area increases and operation speed falls. For example, to reduce random fluctuation distribution σ of the absolute value of the threshold voltage from 10 millivolts to 5 millivolts, it is necessary to quadruple the gate area. As a result, the operation speed falls to a quarter.

When time for applying the negative potential as the reverse bias is too long, downward fluctuation in the threshold voltage is caused by the application of the reverse bias. Therefore, to cancel the upward fluctuation in the threshold voltage caused by the application of the forward bias, it is necessary to heteronomously precisely control the time for applying the negative potential as the reverse bias.

### BRIEF DESCRIPTION OF THE DRAWINGS

FIG. 1 is a block diagram of the schematic configuration of a semiconductor integrated circuit according to a first embodiment;

FIG. 2 is a circuit diagram of the schematic configuration of a semiconductor integrated circuit according to a second embodiment;

FIG. 3 is a timing chart for explaining a method of correcting an absolute value of a threshold voltage of the semiconductor integrated circuit shown in FIG. 2;

FIG. 4 is a circuit diagram of the schematic configuration of a semiconductor integrated circuit according to a third embodiment;

FIG. 5 is a circuit diagram of the schematic configuration of a semiconductor integrated circuit according to a fourth embodiment;

FIGS. 6A and 6B are circuit diagrams of the schematic configuration of a semiconductor integrated circuit according to a fifth embodiment; and

FIGS. 7A and 7B are circuit diagrams of the schematic configuration of a semiconductor integrated circuit according to a sixth embodiment.

### DETAILED DESCRIPTION

A semiconductor integrated circuit comprises an electronic circuit and a correction circuit. The electronic circuit includes a plurality of semiconductor elements. The correction circuit controls voltage of the semiconductor elements such that a difference between electric characteristics of the semiconductor elements autonomously decreases.

Exemplary embodiments are explained in detail below with reference to the accompanying drawings. The present invention is not limited by the embodiments.

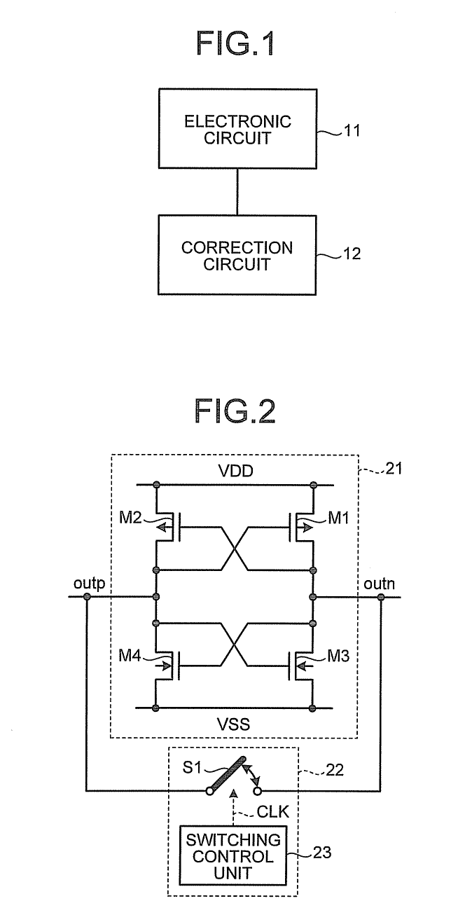

FIG. 1 is a block diagram of the schematic configuration of a semiconductor integrated circuit according to a first embodiment.

In FIG. 1, a semiconductor integrated circuit 1 includes an electronic circuit 11 and a correction circuit 12. The electronic circuit 11 can include a plurality of semiconductor elements. As the semiconductor elements, for example field effect transistors can be used. The electronic circuit 1 can be, for example, a latch circuit, a current mirror circuit, a comparator, a differential amplifier circuit, an analog-to-digital (AD) converter circuit, a digital-to-analog (DA) converter circuit, an inverter, a flip-flop, a shift register, or a static random access memory (SRAM).

The correction circuit 12 can control voltage between the semiconductor elements included in the electronic circuit 11 such that a difference between electric characteristics of the semiconductor elements autonomously decreases. The semiconductor elements may operate in a complementary style each other. When the difference between the electric characteristics of the semiconductor elements included in the electronic circuit 11 is equal to or smaller than a predetermined value, the correction circuit 12 can maintain the difference between the electric characteristics of the semiconductor elements equal to or smaller than the predetermined value by interchanging the semiconductor element in an operation state and the semiconductor element in a stationary state.

For example, when the difference between the electric characteristics of the semiconductor elements included in the electronic circuit 11 is larger than a deterioration amount of the electric characteristics in a predetermined period, the correction circuit 12 can advance deterioration of one of the semiconductor elements such that the difference between the electric characteristics decreases. When the difference between the electric characteristics of the semiconductor elements included in the electronic circuit 11 is smaller than the deterioration amount of the electric characteristics in the predetermined period, the correction circuit 12 can alternately advance, for each predetermined period, deterioration of the semiconductor elements having the difference between the electric characteristics.

Examples of the electric characteristics of the semiconductor elements include an absolute value of a threshold voltage of a field effect transistor. For example, when the electronic circuit 11 is a latch circuit, the correction circuit 12 can reduce fluctuation in absolute values of threshold voltages between field effect transistors included in the latch circuit by periodically short-circuiting output terminals of the latch circuit and periodically initializing the latch circuit.

Consequently, even when fluctuation occurs in the absolute values of the threshold voltages between the field effect transistors included in the latch circuit because of a manufacturing process or fluctuation occurs because of deterioration with time due to NBTI or the like, it is possible to autonomously correct the fluctuation in the absolute values of the threshold voltages between the field effect transistors.

For example, when the electronic circuit 1 is a current mirror circuit, the correction circuit 12 can periodically short-circuit, after changing connection such that field effect transistors included in the current mirror circuit operate as a latch circuit, output terminals of the latch circuit and periodically initialize the latch circuit.

Consequently, even when fluctuation occurs in absolute values of threshold voltages between the field effect transistors included in the current mirror circuit because of a manufacturing process or fluctuation occurs because of deterioration with time due to NBTI or the like, it is possible to autonomously correct the fluctuation in the absolute values of the threshold voltages between the field effect transistors.

FIG. 2 is a circuit diagram of the schematic configuration of a semiconductor integrated circuit according to a second embodiment.

In FIG. 2, the semiconductor integrated circuit includes a latch circuit 21 and a reset circuit 22. The latch circuit 21 includes P-channel field effect transistors M1 and M2 and N-channel field effect transistors M3 and M4. Sources of the P-channel field effect transistors M1 and M2 are connected to power supply potential VDD. Gates of the P-channel field effect transistors M1 and M2 are cross-couple connected to drains of the P-channel field effect transistors M2 and M1. Sources of the N-channel field effect transistors M3 and M4 are connected to power supply potential VSS. Gates of the N-channel field effect transistors M3 and M4 are cross-couple connected to drains of the P-channel field effect transistors M4 and M3. The drain of the P-channel field effect transistor M1 is connected to a drain of the N-channel field effect transistor M3. The drain of the P-channel field effect transistor M2 is connected to a drain of the N-channel field effect transistor M4.

The drain of the P-channel field effect transistor M1 and the drain of the N-channel field effect transistor M3 are connected to an output terminal outn of the latch circuit 21. The drain of the P-channel field effect transistor M2 and the drain of the N-channel field effect transistor M4 are connected to an output terminal outp of the latch circuit 21.

The reset circuit 22 includes a switch S1 and a switching control unit 23. The switch 51 can include a field effect transistor or a gate circuit. The switch S1 is connected between the output terminals outn and outp of the latch circuit 21. The switch S1 can open and short-circuit the output terminals outn and outp of the latch circuit 21. The switching control unit 23 can periodically short-circuit the output terminals outn and outp of the latch circuit 21 and periodically initialize the latch circuit 21. When the latch circuit 21 is initialized, a positive feedback loop gain of the latch circuit 21 only has to be equal to or smaller than one and potentials at the output terminals outn and outp of the latch circuit 21 only have to be substantially equal. A period H for short-circuiting the output terminals outn and outp of the latch circuit 21 can be set, for example, in nanosecond order.

The element characteristics of the P-channel field effect transistor M1,M2 may be equal. That is to say, the element characteristics of a plurality of semiconductor elements which can operate in a complementary style each other may be equal.

This means that the element characteristics of the P-channel field effect transistor M1,M2 may be equal in the design stage. The element characteristics of the P-channel field effect transistor M1,M2 may be different in the semiconductor manufacturing process.

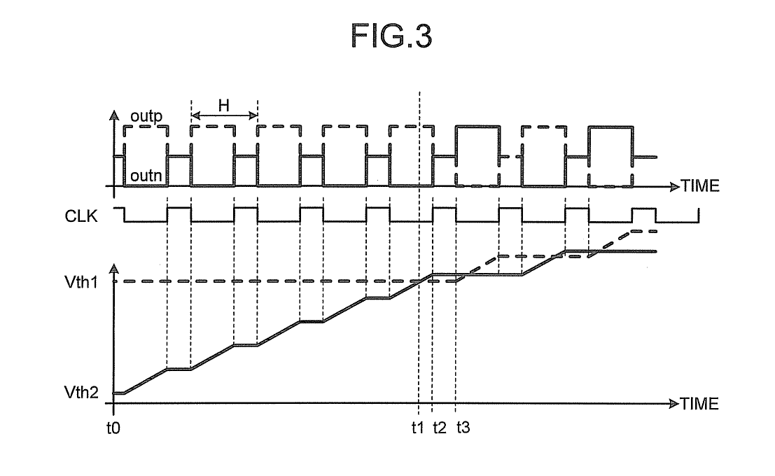

FIG. 3 is a timing chart for explaining a method of correcting an absolute value of a threshold voltage of the semiconductor integrated circuit shown in FIG. 2.

In FIG. 3, it is assumed that, at time t0, an absolute value of a threshold voltage Vth1 of the P-channel field effect transistor M1 is larger than an absolute value of a threshold voltage Vth2 of the P-channel field effect transistor M2 because of deterioration with time due to NBTI or fluctuation in a manufacturing process.

During correction operation for the absolute values of the threshold voltages Vth1 and Vth2 of the P-channel field effect transistors M1 and M2, the switching control unit 23 outputs a switching control signal CLK to the switch S1 to periodically turn on and off the switch S1. At time t0 to t1, when the switch S1 is off, electric current more easily flows to the P-channel field effect transistor M2 having the smaller absolute value of the threshold voltage Vth2. Therefore, the gate potential of the P-channel field effect transistor M1 tends to be drawn to the power supply potential VDD. Therefore, the P-channel field effect transistor M1 is turned off and the P-channel field effect transistor M2 is turned on. The potential at the output terminal outn of the latch circuit 21 changes to a low level and the potential at the output terminal outp of the latch circuit 21 changes to a high level. Therefore, the absolute value of the threshold voltage Vth1 of the P-channel field effect transistor M1 is maintained. The absolute value of the threshold voltage Vth2 of the P-channel field effect transistor M2 increases. As a result, a difference between the absolute values of the threshold voltages Vth1 and Vth2 of the P-channel field effect transistors M1 and M2 decreases.

When the potential at the output terminal outn of the latch circuit 21 is at the low level and the potential at the output terminal outp of the latch circuit 21 is at the high level, the N-channel field effect transistor M3 is turned on and the N-channel field effect transistor M4 is turned off.

When the switch S1 is turned on, the potentials at the output terminals outn and outp of the latch circuit 21 are equalized and the absolute values of the threshold voltages Vth1 and Vth2 of the P-channel field effect transistors M1 and M2 are maintained.

When the switch S1 is turned off again, while the absolute value of the threshold voltage Vth2 of the P-channel field effect transistor M2 is smaller than the absolute value of the threshold voltage Vth1 of the P-channel field effect transistor M1, the P-channel field effect transistor M2 is autonomously turned on. Therefore, the absolute value of the threshold voltage Vth2 of the P-channel field effect transistor M2 increases. As a result, the difference between the absolute values of the threshold voltages Vth1 and Vth2 of the P-channel field effect transistors M1 and M2 further decreases.

When the switch S1 is repeatedly turned on and off according to the predetermined period H, while the absolute value of the threshold voltage Vth2 of the P-channel field effect transistor M2 is smaller than the absolute value of the threshold voltage Vth1 of the P-channel field effect transistor M1, the P-channel field effect transistor M2 is autonomously turned on. Therefore, the absolute value of the threshold voltage Vth2 of the P-channel field effect transistor M2 gradually increases. As a result, the difference between the absolute values of the threshold voltages Vth1 and Vth2 of the P-channel field effect transistors M1 and M2 gradually decreases.

It is assumed that the absolute values of the threshold voltages Vth1 and Vth2 of the P-channel field effect transistors M1 and M2 are equalized at time t1. After time t1, while the switch S1 is off, the N-channel field effect transistor M3 is kept on and the N-channel field effect transistor M4 is kept off. The absolute value of the threshold voltage Vth2 of the P-channel field effect transistor M2 becomes larger than the absolute value of the threshold voltage Vth1 of the P-channel field effect transistor M1.

When the switch S1 is turned on at time t2, the potentials at the output terminals outn and outp of the latch circuit 21 are equalized. The absolute values of the threshold voltages Vth1 and Vth2 of the P-channel field effect transistors M1 and M2 are maintained.

When the switch S1 is turned off again at time t3, because the absolute value of the threshold voltage Vth1 of the P-channel field effect transistor M1 is smaller than the absolute value of the threshold voltage Vth2 of the P-channel field effect transistor M2, the P-channel field effect transistor M1 is autonomously turned on. Therefore, the absolute value of the threshold voltage Vth1 of the P-channel field effect transistor M1 increases. As a result, the absolute value of the threshold voltage Vth1 of the P-channel field effect transistor M1 becomes larger than the absolute value of the threshold voltage Vth2 of the P-channel field effect transistor M2.

When the switch S1 is repeatedly turned on and off according to the predetermined period H, the absolute values of the threshold voltages Vth1 and Vth2 of the P-channel field effect transistors M1 and M2 alternately increase. The P-channel field effect transistors M1 and M2 are alternately turned on.

After time t1, it is possible to increase the absolute values of the threshold voltages Vth1 and Vth2 of the P-channel field effect transistors M1 and M2 while interchanging, according to the predetermined period H, the P-channel field effect transistors M1 and M2, the absolute values of the threshold voltages Vth1 and Vth2 of which increase because of NBTI. Therefore, even when the switching control signal CLK is applied until arbitrary time after time t1, the difference between the absolute values of the threshold voltages Vth1 and Vth2 of the P-channel field effect transistors M1 and M2 can be reduced to be equal to or smaller than an increase in the absolute values of the threshold voltages Vth1 and Vth2 of the P-channel field effect transistors M1 and M2 that occurs within the predetermined period H. This makes it possible to autonomously correct fluctuation in the absolute values of the threshold voltages Vth1 and Vth2 between the P-channel field effect transistors M1 and M2.

On the other hand, during normal operation of the latch circuit 21 shown in FIG. 2, the switching control unit 23 stops the output of the switching control signal CLK and keeps the switch S1 off to open the output terminals outn and outp of the latch circuit 21.

This makes it unnecessary to increase gate areas of the P-channel field effect transistors M1 and M2 to suppress the fluctuation in the absolute values of the threshold voltages Vth1 and Vth2 between the P-channel field effect transistors M1 and M2. After time t1, the application of the switching control signal CLK can be stopped at any time. It is unnecessary to strictly manage application time of the switching control signal CLK. Therefore, it is possible to prevent a circuit area from increasing and prevent operation speed from falling.

Correction operation for the absolute values of the threshold voltages Vth1 and Vth2 can be performed at any time as long as power is supplied to the semiconductor integrated circuit but the operation of the semiconductor integrated circuit is stopped. For example, the correction operation for the absolute values of the threshold voltages Vth1 and Vth2 can be started when the semiconductor integrated circuit is powered on.

Alternatively, the correction operation for the absolute values of the threshold voltages Vth1 and Vth2 can be started during burn-in before shipment of the semiconductor integrated circuit. During the burn-in, the power supply potential VDD and operation temperature can be set rather high compared with those during the normal operation of the latch circuit 21 and deterioration with time due to NBTI can be accelerated. Therefore, time required for correction of the absolute values of the threshold voltages Vth1 and Vth2 can be reduced. The normal operation of the latch circuit 21 means the operation other than the correction operation of the latch circuit 21.

Time prepared for the correction operation for the absolute values of the threshold voltages Vth1 and Vth2 can be determined in advance. For example, it is also possible to provide a timer in the reset circuit 22 shown in FIG. 2, start the timer when the power supply for the semiconductor integrated circuit is turned on, and perform the correction operation for time set by the timer.

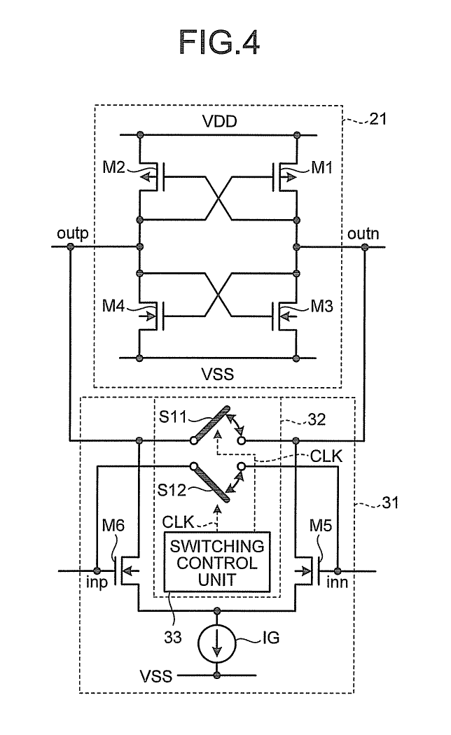

FIG. 4 is a circuit diagram of the schematic configuration of a semiconductor integrated circuit according to a third embodiment.

In FIG. 4, the semiconductor integrated circuit includes the latch circuit 21, a differential amplifier circuit 31, and a reset circuit 32. The latch circuit 21 and the differential amplifier circuit 31 configure a comparator. The differential amplifier circuit 31 includes N-channel field effect transistors M5 and M6 and a current source IG. Drains of the N-channel field effect transistors M5 and M6 are respectively connected to the output terminals outn and outp of the latch circuit 21. Sources of the N-channel field effect transistors M5 and M6 are connected to the power supply potential VSS via the current source IG. Gates of the N-channel field effect transistors M5 and M6 are connected to input terminals inn and inp of the differential amplifier circuit 31.

The reset circuit 32 includes switches S11 and S12 and a switching control unit 33. The switches S11 and S12 can include field effect transistors or gate circuits. The switch S11 is connected between the output terminals outn and outp of the latch circuit 21. The switch S11 can open and short-circuit the output terminals outn and outp of the latch circuit 21. The switch S12 is connected between the input terminals inn and inp of the differential amplifier circuit 31. The switch S12 can open and short-circuit the input terminals inn and inp of the differential amplifier circuit 31. When the switch S11 is turned on, the switch S12 is synchronously turned on. When the switch S11 is turned off, the switch S12 is synchronously turned off.

The switching control unit 33 can periodically short-circuit the output terminals outn and outp of the latch circuit 21, periodically short-circuit the input terminals inn and inp of the differential amplifier circuit 31, and periodically initialize the latch circuit 21.

During correction operation for the absolute values of the threshold voltages Vth1 and Vth2 of the P-channel field effect transistors M1 and M2, the switching control unit 33 outputs the switching control signal CLK to the switches S11 and S12 to periodically turn on and off the switches S11 and S12. The switching control unit 33 turns on the switch S12 in synchronization with turning-on of the switch S11. This makes it possible to, even when there is a potential difference between the input terminals inn and inp, equalize the potentials at the output terminals outn and outp of the latch circuit 21 and stably reset the latch circuit 21.

The switches S11 and S12 are turned on and off at the predetermined period H. When a difference between the absolute values of the threshold voltages Vth1 and Vth2 of the P-channel field effect transistors M1 and M2 is larger than an increase in the absolute values of the threshold voltages Vth1 and Vth2 of the P-channel field effect transistors M1 and M2 that occurs within the predetermined period H, the P-channel field effect transistors M1 and M2 are turned on and off to reduce the difference.

When the difference between the absolute values of the threshold voltages Vth1 and Vth2 of the P-channel field effect transistors M1 and M2 is smaller than the increase in the absolute values of the threshold voltages Vth1 and Vth2 of the P-channel field effect transistors M1 and M2 that occurs within the predetermined period H, the P-channel field effect transistors M1 and M2 are alternately turned on and off according to the predetermined period H. The absolute values of the threshold voltages Vth1 and Vth2 of the P-channel field effect transistors M1 and M2 are alternately increased.

On the other hand, during normal operation of the comparator shown in FIG. 4, the switching control unit 33 stops the output of the switching control signal CLK and keeps the switches S11 and S12 off to open the output terminals outn and outp of the latch circuit 21 and open the input terminals inn and inp of the differential amplifier circuit 31.

This makes it possible to autonomously correct, even when the comparator includes the latch circuit 21, fluctuation in the absolute values of the threshold voltages Vth1 and Vth2 between the P-channel field effect transistors M1 and M2.

In the third embodiment, a method of providing the switch S12 between the input terminals inn and inp of the differential amplifier circuit 31 to stably reset the latch circuit 21 is explained. However, the switch S12 does not always have to be provided when the comparator is used under a condition that there is no potential difference between the input terminals inn and inp.

When switches connected in the same manner as the switches S11 and S12 or functions equivalent to the switches S11 and S12 are included in the comparator itself, the switches or the functions are used as the switches S11 and S12. This makes it possible to realize the reset function without providing the switches S11 and S12 exclusively for the reset function.

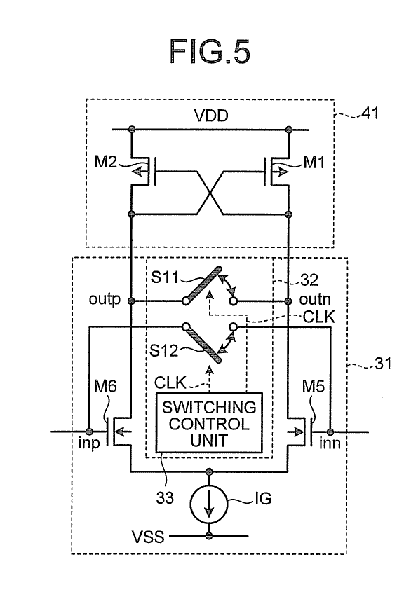

FIG. 5 is a circuit diagram of the schematic configuration of a semiconductor integrated circuit according to a fourth embodiment.

In FIG. 5, the semiconductor integrated circuit includes a latch circuit 41, the differential amplifier circuit 31, and the reset circuit 32. The latch circuit 41 and the differential amplifier circuit 31 configure a comparator. The latch circuit 41 includes the P-channel field effect transistors M1 and M2. The sources of the P-channel field effect transistors M1 and M2 are connected to the power supply potential VDD. The gates of the P-channel field effect transistors M1 and M2 are cross-couple connected to the drains of the P-channel field effect transistors M2 and M1. The drain of the P-channel field effect transistor M1 is connected to the drain of the N-channel field effect transistor M5. The drain of the P-channel field effect transistor M2 is connected to the drain of the N-channel field effect transistor M6.

During correction operation for the absolute values of the threshold voltages Vth1 and Vth2 of the P-channel field effect transistors M1 and M2, the switching control unit 33 outputs the switching control signal CLK to the switches S11 and S12 to periodically turn on and off the switches S11 and S12.

The switches S11 and S12 are turned on and off at the predetermined period H. When a difference between the absolute values of the threshold voltages Vth1 and Vth2 of the P-channel field effect transistors M1 and M2 is larger than an increase in the absolute values of the threshold voltages Vth1 and Vth2 of the P-channel field effect transistors M1 and M2 that occurs within the predetermined period H, the P-channel field effect transistors M1 and M2 are turned on and off to reduce the difference.

When the difference between the absolute values of the threshold voltages Vth1 and Vth2 of the P-channel field effect transistors M1 and M2 is smaller than the increase in the absolute values of the threshold voltages Vth1 and Vth2 of the P-channel field effect transistors M1 and M2 that occurs within the predetermined period H, the P-channel field effect transistors M1 and M2 are alternately turned on and off according to the predetermined period H. The absolute values of the threshold voltages Vth1 and Vth2 of the P-channel field effect transistors M1 and M2 are alternately increased.

On the other hand, during normal operation of the comparator shown in FIG. 5, the switching control unit 33 stops the output of the switching control signal CLK and keeps the switches S11 and S12 off to open the output terminals outn and outp of the latch circuit 41 and open the input terminals inn and inp of the differential amplifier circuit 31.

This makes it possible to autonomously correct, even when the latch circuit 41 obtained by simplifying the latch circuit 21 is used, fluctuation in the absolute values of the threshold voltages Vth1 and Vth2 between the P-channel field effect transistors M1 and M2.

In the fourth embodiment, a method of providing the switch S12 between the input terminals inn and inp of the differential amplifier circuit 31 to stably reset the latch circuit 21 is explained. However, the switch S12 does not always have to be provided when the comparator is used under a condition that there is no potential difference between the input terminals inn and inp.

When switches connected in the same manner as the switches S11 and S12 or functions equivalent to the switches S11 and S12 are included in the comparator itself, the switches or the functions are used as the switches S11 and S12. This makes it possible to realize the reset function without providing the switches S11 and S12 exclusively for the reset function.

In the fourth embodiment, the comparator including the latch circuit 41 is explained as an example. However, the present invention can be applied when the latch circuit 41 is independently used.

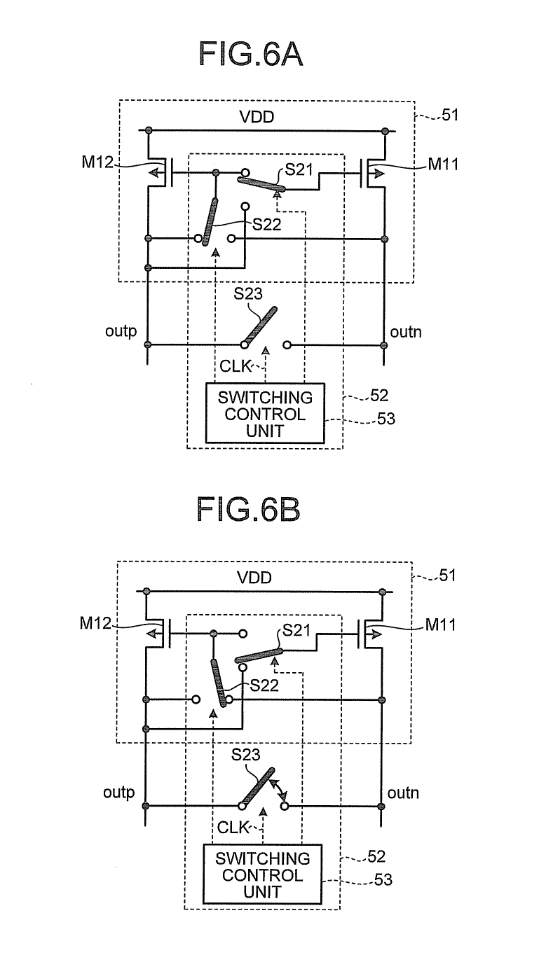

FIGS. 6A and 6B are circuit diagrams of the schematic configuration of a semiconductor integrated circuit according to a fifth embodiment. A state in which the semiconductor integrated circuit is made to operate as a current mirror circuit is shown in FIG. 6A. A state in which the current mirror circuit shown in FIG. 6A is made to operate as a latch circuit is shown in FIG. 6B.

In FIGS. 6A and 6B, the semiconductor integrated circuit includes a current mirror circuit 51 and a reset circuit 52. The current mirror circuit 51 includes 2-channel field effect transistors M11 and M12. Sources of the P-channel field effect transistors M11 and M12 are connected to the power supply potential VDD. A drain of the P-channel field effect transistor M11 is connected to an output terminal outn of the current mirror circuit 51. A drain of the P-channel field effect transistor M12 is connected to an output terminal outp of the current mirror circuit 51.

The reset circuit 52 includes switches S21 to S23 and a switching control unit 53. The switches S21 to S23 can include field effect transistors or gate circuits. The switch S21 can switch a connection destination of a gate of the P-channel field effect transistor M11 between a gate and the drain of the P-channel field effect transistor M12. The switch S22 can switch a connection destination of the gate of the P-channel field effect transistor M12 between the drain of the P-channel field effect transistor M11 and the drain of the P-channel field effect transistor M12. The switch S23 is connected between the output terminals outn and outp of the current mirror circuit 51. The switch S23 can open and short-circuit the output terminals outn and outp of the current mirror circuit 51.

When the current mirror circuit 51 is caused to operate, the switching control unit 53 can change over the switch S21 to connect the gate of the P-channel field effect transistor M11 to the gate of the P-channel field effect transistor M12 and can change over the switch S22 to connect the gate of the P-channel field effect transistor M12 to the drain of the P-channel field effect transistor M12.

When the current mirror circuit 51 is made to operate as a latch circuit, the switching control unit 53 can change over the switch S21 to connect the gate of the P-channel field effect transistor M11 to the drain of the P-channel field effect transistor M12 and can change over the switch S22 to connect the gate of the P-channel field effect transistor M12 to the drain of the P-channel field effect transistor M11.

When the current mirror circuit 51 is made to operate as a latch circuit, the switching control unit 53 can periodically short-circuit the output terminals outn and outp of the current mirror circuit 51 and periodically initialize the latch circuit including the P-channel field effect transistors M11 and M12.

As shown in FIG. 6A, when the current mirror circuit 51 is caused to operate, the switching control unit 53 changes over the switch S21 to connect the gate of the P-channel field effect transistor M11 to the gate of the P-channel field effect transistor M12 and changes over switch S22 to connect the gate of the P-channel field effect transistor M12 to the drain of the P-channel field effect transistor M12. The switching control unit 53 stops the output of the switching control signal CLK and keeps the switch S23 off to open the output terminals outn and outp of the current mirror circuit 51.

On the other hand, during correction operation for the absolute values of the threshold voltages Vth1 and Vth2 of the P-channel field effect transistors M11 an M12, as shown in FIG. 6B, the switching control unit 53 changes over the switch S21 to connect the gate of the P-channel field effect transistor M11 to the drain of the P-channel field effect transistor M12 and changes over the switch S22 to connect the gate of the P-channel field effect transistor M12 to the drain of the P-channel field effect transistor M11. Consequently, the P-channel field effect transistors M11 and M12 configure a latch circuit.

The switching control unit 53 outputs the switching control signal CLK to the switch S23 to periodically turn on and off the switch S23.

The switch S23 is turned on and off at the predetermined period H. When a difference between the absolute values of the threshold voltages Vth1 and Vth2 of the P-channel field effect transistors M11 and M12 is larger than an increase in the absolute values of the threshold voltages Vth1 and Vth2 of the P-channel field effect transistors M11 and M12 that occurs within the predetermined period H, the P-channel field effect transistors M11 and M12 are turned on and off to reduce the difference.

When the difference between the absolute values of the threshold voltages Vth1 and Vth2 of the P-channel field effect transistors M11 and M12 is smaller than the increase in the absolute values of the threshold voltages Vth1 and Vth2 of the P-channel field effect transistors M11 and M12 that occurs within the predetermined period H, the P-channel field effect transistors M11 and M12 are alternately turned on and off according to the predetermined period H. The absolute values of the threshold voltages Vth1 and Vth2 of the P-channel field effect transistors M11 and M12 are alternately increased.

This makes it possible to cause the P-channel field effect transistors M11 and M12 to operate as a latch circuit while making it possible to configure the current mirror circuit 51 with the P-channel field effect transistors M11 and M12. As a result, it is possible to autonomously correct fluctuation in the absolute values of the threshold voltages Vth1 and Vth2 between the P-channel field effect transistors M11 and M12.

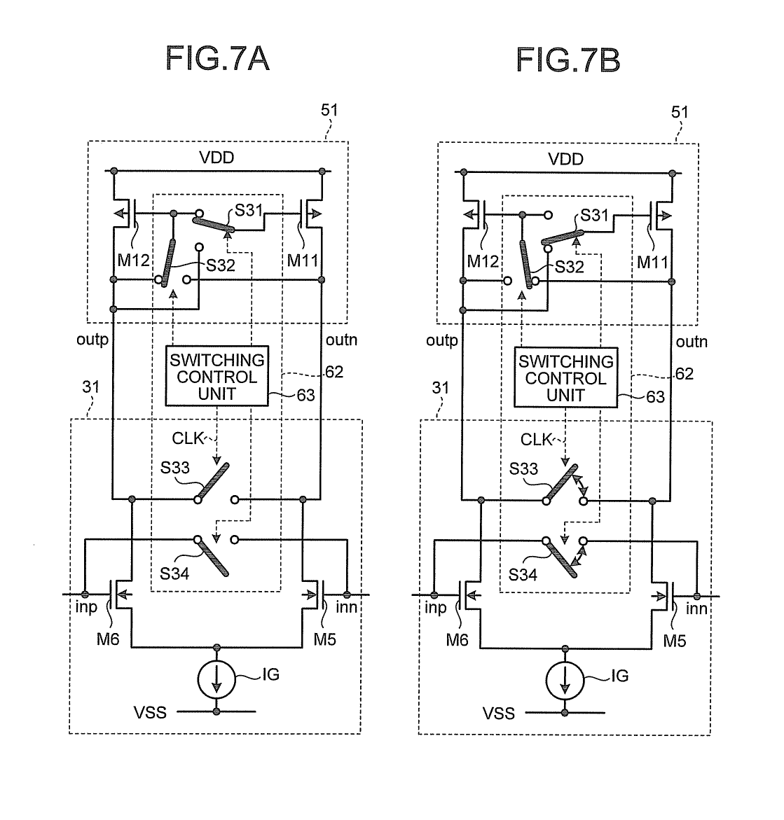

FIGS. 7A and 7B are circuit diagrams of the schematic configuration of a semiconductor integrated circuit according to a sixth embodiment. A state in which the semiconductor integrated circuit is made to operate as a differential amplifier is shown in FIG. 7A. A state in which the differential amplifier shown in FIG. 7A is made to operate as a latch circuit is shown in FIG. 7B.

In FIGS. 7A and 7B, the semiconductor integrated circuit includes the current mirror circuit 51, the differential amplifier circuit 31, and a reset circuit 62. The drain of the P-channel field effect transistor M11 and M12 are connected to the drains of the N-channel field effect transistors M5 and M6 respectively.

The reset circuit 62 includes switches S31 to S34 and a switching control unit 63. The switches S31 to S34 can include field effect transistors or gate circuits. The switch S31 can switch a connection destination of the gate of the P-channel field effect transistor M11 between the gate and the drain of the P-channel field effect transistor M12. The switch S32 can switch a connection destination of the gate of the P-channel field effect transistor M12 between the drain of the P-channel field effect transistor M11 and the drain of the P-channel field effect transistor M12. The switch S33 is connected between the output terminals outn and outp of the current mirror circuit 51. The switch S33 can open and short-circuit the output terminals outn and outp of the current mirror circuit 51. The switch S34 is connected between the input terminals inn and inp of the differential amplifier circuit 31. The switch S34 can open and short-circuit the input terminals inn and inp of the differential amplifier circuit 31.

When the current mirror circuit 51 is caused to operate, the switching control unit 63 can change over the switch S31 to connect the gate of the P-channel field effect transistor M11 to the gate of the P-channel field effect transistor M12 and can change over the switch S32 to connect the gate of the P-channel field effect transistor M12 to the drain of the P-channel field effect transistor M12.

When the current mirror circuit 51 is made to operate as a latch circuit, the switching control unit 63 can change over the switch S31 to connect the gate of the P-channel field effect transistor M11 to the drain of the P-channel field effect transistor M12 and can change over the switch S32 to connect the gate of the P-channel field effect transistor M12 to the drain of the P-channel field effect transistor M11.

When the current mirror circuit 51 is made to operate as a latch circuit, the switching control unit 63 can periodically short-circuit the output terminals outn and outp of the current mirror circuit 51, periodically short-circuit the input terminals inn and inp of the differential amplifier circuit 31, and periodically initialize the latch circuit including the P-channel field effect transistors M11 and M12.

As shown in FIG. 7A, when the current mirror circuit 51 is caused to operate, the switching control unit 63 changes over the switch S31 to connect the gate of the P-channel field effect transistor M11 to the gate of the P-channel field effect transistor M12 and changes over the switch S32 to connect the gate of the P-channel field effect transistor M12 to the drain of the P-channel field effect transistor M12. The switching control unit 63 stops the output of the switching control signal CLK and keeps the switches S33 and S34 off to open the output terminals outn and outp of the current mirror circuit 51 and open the input terminals inn and inp of the differential amplifier circuit 31.

On the other hand, during correction operation for the absolute values of the threshold voltages Vth1 and Vth2 of the P-channel field effect transistors M11 and M12, as shown in FIG. 7B, the switching control unit 63 changes over the switch S31 to connect the gate of the P-channel field effect transistor M11 to the drain of the P-channel field effect transistor M12 and changes over the switch S32 to connect the gate of the P-channel field effect transistor M12 to the drain of the P-channel field effect transistor M11. Consequently, the P-channel field effect transistors M11 and M12 configure a latch circuit.

The switching control unit 63 outputs the switching control signal CLK to the switches S33 and S34 and periodically turns on and off the switches S33 and S34.

The switches S33 and S34 are turned on and off at the predetermined period H. When a difference between the absolute values of the threshold voltages Vth1 and Vth2 of the P-channel field effect transistors M11 and M12 is larger than an increase in the absolute values of the threshold voltages Vth1 and Vth2 of the P-channel field effect transistors M11 and M12 that occurs within the predetermined period H, the P-channel field effect transistors M11 and M12 are turned on and off to reduce the difference.

When the difference between the absolute values of the threshold voltages Vth1 and Vth2 of the P-channel field effect transistors M11 and M12 is smaller than the increase in the absolute values of the threshold voltages Vth1 and Vth2 of the P-channel field effect transistors M11 and M12 that occurs within the predetermined period H, the P-channel field effect transistors M11 and M12 are alternately turned on and off according to the predetermined period H. The absolute values of the threshold voltages Vth1 and Vth2 of the P-channel field effect transistors M11 and M12 are alternately increased.

This makes it possible to cause the P-channel field effect transistors M11 and M12 to operate as a latch circuit even when a differential amplifier includes the current mirror circuit 51. As a result, it is possible to autonomously correct fluctuation in the absolute values of the threshold voltages Vth1 and Vth2 between the P-channel field effect transistors M11 and M12.

Besides the configuration examples explained above, the present invention can be applied to any circuit even if the circuit is not made to operate as a latch circuit during normal operation as long as connection of the circuit can be switched by using a switch to cause the switch to operate as the latch circuit.

In the embodiments, the method of correcting fluctuation in absolute values of threshold voltages between field effect transistors due to negative bias temperature instability (NBTI) is explained as an example. However, the present invention is also suitably applied to correction of fluctuation in absolute values of threshold voltages between field effect transistors due to positive bias temperature instability (PBTI). In this case, it is sufficient to interchange the P-channel field effect transistor and the N-channel field effect transistor, interchange the power supply potential VDD and the power supply potential VSS, and reverse the direction of the current source.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor integrated circuit comprising:
an electronic circuit including a plurality of semiconductor elements; and
a correction circuit that controls voltage of the semiconductor elements such that a difference between electric characteristics of the semiconductor elements autonomously decreases.

2. The semiconductor integrated circuit according to claim 1, wherein the correction circuit interchanges, when the difference between the electric characteristics of the semiconductor elements is equal to or smaller than a predetermined value, the semiconductor element in an operation state and the semiconductor element in a stationary state to maintain the difference between the electric characteristics of the semiconductor elements equal to or smaller than the predetermined value.

3. The semiconductor integrated circuit according to claim 1, wherein the correction circuit advances, when the difference between the electric characteristics of the semiconductor elements is larger than a deterioration amount of the electric characteristics within a predetermined period, deterioration of only one of the semiconductor elements such that the difference between the electric characteristics decreases.

4. The semiconductor integrated circuit according to claim 1, wherein
the electronic circuit includes first and second field effect transistors, gates of which are cross-couple connected to drains thereof each other,
the correction circuit autonomously turns on the first field effect transistor and increases the absolute value of the threshold voltage of the first field effect transistor, while an absolute value of a threshold voltage of the first field effect transistor is smaller than an absolute value of a threshold voltage of the second field effect transistor, to reduce a difference between the absolute values of the threshold voltages of the first and second field effect transistors, and
the correction circuit autonomously turns on the second field effect transistor and increases the absolute value of the threshold voltage of the second field effect transistor, while the absolute value of the threshold voltage of the second field effect transistor is smaller than the absolute value of the threshold voltage of the first field effect transistor, to reduce the difference between the absolute values of the threshold voltages of the first and second field effect transistors

5. The semiconductor integrated circuit according to claim 4, wherein element characteristics of the first and second field effect transistors are equal.

6. The semiconductor integrated circuit according to claim 4, wherein the correction circuit alternately turns on, when the difference between the absolute values of the threshold voltages of the first and second field effect transistors is equal to or smaller than a predetermine value, the first and second field effect transistors to maintain the difference between the absolute values of the threshold voltages of the first and second field effect transistors equal to or smaller than the predetermined value.

7. The semiconductor integrated circuit according to claim 4, wherein the correction circuit advances, when the difference between the absolute values of the threshold voltages of the first and second field effect transistors is larger than a deterioration amount of the electric characteristics within a predetermined period, deterioration of only one of the first and second field effect transistors such that the difference between the absolute values of the threshold voltages of the first and second field effect transistors decreases.

8. A semiconductor integrated circuit comprising:
a latch circuit including a plurality of field effect transistors; and
a reset circuit that periodically initializes the latch circuit, and that controls voltage of the field effect transistors such that a difference between electric characteristics of the field effect transistors autonomously decreases.

9. The semiconductor integrated circuit according to claim 8, wherein the reset circuit includes:
a switch that short-circuits output terminals of the latch circuit; and
a switching control unit that periodically turns on and off the switch.

10. The semiconductor integrated circuit according to claim 8, wherein the latch circuit includes first and second field effect transistors, gates of which are cross-couple connected to drains thereof each other.

11. The semiconductor integrated circuit according to claim 10, wherein
the reset circuit autonomously turns on the first field effect transistor and increases the absolute value of the threshold voltage of the first field effect transistor while an absolute value of a threshold voltage of the first field effect transistor is smaller than an absolute value of a threshold voltage of the second field effect transistor, to reduce a difference between the absolute values of the threshold voltages of the first and second field effect transistors, and
the reset circuit autonomously turns on the second field effect transistor and increases the absolute value of the threshold voltage of the second field effect transistor while the absolute value of the threshold voltage of the second field effect transistor is smaller than the absolute value of the threshold voltage of the first field effect transistor, to reduce the difference between the absolute values of the threshold voltages of the first and second field effect transistors

12. The semiconductor integrated circuit according to claim 11, wherein the reset circuit alternately turns on, when the difference between the absolute values of the threshold voltages of the first and second field effect transistors is equal to or smaller than a predetermine value, the first and second field effect transistors to maintain the difference between the threshold voltages of the first and second field effect transistors equal to or smaller than the predetermined value.

13. The semiconductor integrated circuit according to claim 12, wherein the latch circuit includes third and fourth field effect transistors of a conduction type opposite to a conduction type of the first and second field effect transistors, the third and fourth field effect transistors being respectively connected in series to the first and second field effect transistors, and gates of the third and fourth field effect transistors being cross-couple connected to drains thereof each other.

14. The semiconductor integrated circuit according to claim 12, further comprising:
a fifth field effect transistor, a drain of which is connected to the drain of the first field effect transistor;
a sixth field effect transistor, a drain of which is connected to the drain of the second field effect transistor; and
a current source connected in common to sources of the fifth and sixth field effect transistors.

15. A semiconductor integrated circuit comprising:
an electronic circuit including a plurality of field effect transistors; and
a reset circuit that changes connection such that the field effect transistors included in the electronic circuit operate as a latch circuit and then periodically initializes the latch circuit, and that controls voltage of the field effect transistors such that a difference between electric characteristics of the field effect transistors autonomously decreases.

16. The semiconductor integrated circuit according to claim 15, wherein the reset circuit includes:
a switch that short-circuits output terminals of the latch circuit; and
a switching control unit that periodically turns on and off the switch.

17. The semiconductor integrated circuit according to claim 16, wherein
the electronic circuit includes:
a first field effect transistor;
a second field effect transistor;
a first switch that connects, when the first and second field effect transistors are made to operate as a current mirror circuit, a gate of the first field effect transistor to a gate of the second field effect transistor and connects, when the first and second field effect transistors are made to operate as the latch circuit, the gate of the first field effect transistor to a drain of the second field effect transistor; and
a second switch that connects, when the first and second field effect transistors are made to operate as the current mirror circuit, the gate of the second field effect transistor to the drain of the second field effect transistor and connects, when the first and second field effect transistors are made to operate as the latch circuit, the gate of the second field effect transistor to a drain of the first field effect transistor.

18. The semiconductor integrated circuit according to claim 17, wherein when the first and second field effect transistors are made to operate as the latch circuit,
the reset circuit autonomously turns on the first field effect transistor and increases the absolute value of the threshold voltage of the first field effect transistor while an absolute value of a threshold voltage of the first field effect transistor is smaller than an absolute value of a threshold voltage of the second field effect transistor, to reduce a difference between the absolute values of the threshold voltages of the first and second field effect transistors, and
the reset circuit autonomously turns on the second field effect transistor and increases the absolute value of the threshold voltage of the second field effect transistor while the absolute value of the threshold voltage of the second field effect transistor is smaller than the absolute value of the threshold voltage of the first field effect transistor, to reduce the difference between the absolute values of the threshold voltages of the first and second field effect transistors

19. The semiconductor integrated circuit according to claim 18, wherein the reset circuit alternately turns on, when the difference between the absolute values of the threshold voltages of the first and second field effect transistors is equal to or smaller than a predetermine value, the first and second field effect transistors to maintain the difference between the threshold voltages of the first and second field effect transistors equal to or smaller than the predetermined value.

20. The semiconductor integrated circuit according to claim 19, further comprising:
a third field effect transistor of a conduction type opposite to a conduction type of the first field effect transistor, a drain of the third field effect transistor being connected to the drain of the first field effect transistor;
a fourth field effect transistor of a conduction type opposite to a conduction type of the second field effect transistor, a drain of the fourth field effect transistor being connected to the drain of the second field effect transistor; and
a current source connected in common to sources of the third and fourth field effect transistors.
